(19) United States
(12) Patent Application Publication
(10) Pub. No.: US 2024/0346849 A1
(43) Pub. Date: Oct. 17, 2024

(54) A METHOD AND A SYSTEM CONFIGURED TO REDUCE IMPACT OF IMPAIRMENT DATA IN CAPTURED IRIS IMAGES

(71) Applicant: FINGERPRINT CARDS ANACATUM IP AB, GÖTEBORG (SE)

(72) Inventor: Mikkel STEGMANN, VANLØSE (DK)

(73) Assignee: FINGERPRINT CARDS ANACATUM IP AB, GÖTEBORG (SE)

(21) Appl. No.: 18/700,080

(22) PCT Filed: Oct. 5, 2022
(86) PCT No.: PCT/SE2022/050892

§ 371 Date: Apr. 10, 2024

(30) Foreign Application Priority Data
Oct. 13, 2021 (SE) 2151252-0

(51) Int. Cl. G06V 40/18; G06T 5/50; G06V 40/50; G06V 40/60

(52) U.S. Cl. CPC G06V 40/197; G06T 5/50; G06V 40/193; G06V 40/50; G06V 40/67; G06T 2207/20216

(57) ABSTRACT

An iris recognition system and method configured to reduce impact of impairment data in captured iris images. The system comprises a camera configured to capture first and second images of a user's iris. A processing unit of the system is configured to cause the user to change gaze between the capturing of the first and second images, create a representation of each of the first and second iris images, where each spatial sample of an image sensor of the camera capturing the iris images is gaze-motion compensated to correspond to a same position on the iris for the sequentially captured first and second iris images, thereby causing the iris to be fixed in the representations while any impairment data will move with the change in gaze of the user, and to filter the moving impairment data from at least one of the representations of the first and second iris images.

### TECHNICAL FIELD

The present disclosure relates to methods of an iris recognition system of reducing impact of impairment data in captured iris images, and an iris recognition system performing the methods.

### BACKGROUND

When capturing images of an eye of a user for performing iris recognition using for instance a camera of a smartphone for subsequently unlocking the smart phone of the user, subtle visual structures and features of the user's iris are identified in the captured image and compared to corresponding features of a previously enrolled iris image in order to find a match. These structures are a strong carrier of eye identity, and by association, subject identity.

Both during authentication and enrolment of the user, accurate detection of these features is pivotal for performing reliable iris recognition.

A captured iris image may be subjected to interference or noise, for instance due to image sensor imperfections, scratches or dirt on the camera lens, interfering light impinging on the user's eye, objects being present between the camera and the user, etc.

Such interference or noise may cause impairment data to occur in a captured iris image which ultimately will result in less accurate detection and extraction of iris features in a captured image and even false accepts to occur during the authentication of the user.

### SUMMARY

One object is to solve, or at least mitigate, this problem in the art and thus provide improved methods of an iris recognition system of reducing impact of impairment data in captured iris images.

This object is attained in a first aspect by a method of an iris recognition system of reducing impact of impairment data in captured iris images. The method comprises capturing a first image of an iris of a user, causing the user to change gaze, capturing at least a second image of the iris of the user, and detecting data in the first and the second iris image as impairment data if a location of said data is fixed in the first and the second iris image.

This object is attained in a second aspect by an iris recognition system configured to reduce impact of impairment data in captured iris images. The iris recognition system comprises a camera configured to capture a first image of an iris of a user and at least a second image of the iris of the user. The iris recognition system further comprises a processing unit being configured to cause the user to change gaze between the capturing of the first image and the at least one second image and to detect data in the first and the second iris image as impairment data if a location of said data is fixed in the first and the second iris image.

Advantageously, by causing the user to change gaze—for instance by presenting a visual pattern on a display of a smart phone in which the iris recognition system is implemented-any data caused by interference will remain in a fixed position while a position of the iris will change with the change in gaze and the fixed-position data may thus be detected as impairment data.

In an embodiment, any iris features positioned at the location of the detected impairment data in the captured iris images will be disregarded during authentication and/or enrolment of the user.

In another embodiment, iris features in the captured iris images where the detected impairment data resides at a location outside of the iris of the user is selected for authentication and/or enrolment of the user.

This object is attained in a third aspect by a method of an iris recognition system of reducing impact of impairment data in captured iris images. The method comprises capturing a first image of an iris of a user, causing the user to change gaze, and capturing at least a second image of the iris of the user. The method further comprises creating a representation of the first iris image and a representation of the at least one second iris image where each spatial sample of an image sensor of a camera capturing the iris images is gaze-motion compensated to correspond to a same position on the iris for the sequentially captured first and at least one second iris images, thereby causing the iris to be fixed in the representations of the first and at least one second iris images while any impairment data will move with the change in gaze of the user, and filtering the moving impairment data from at least one of the created representations of the first and at least one second iris images.

This object is attained in a fourth aspect by an iris recognition system configured to reduce impact of impairment data in captured iris images. The system comprises a camera configured to capture a first image of an iris of a user and at least a second image of the iris of the user. The system further comprises a processing unit being configured to cause the user to change gaze between the capturing of the first image and the at least one second image, create a representation of the first iris image and a representation of the at least one second iris image where each spatial sample of an image sensor of the camera capturing the iris images is gaze-motion compensated to correspond to a same position on the iris for the sequentially captured first and at least one second iris images, thereby causing the iris to be fixed in the representations of the first and at least one second iris images while any impairment data will move with the change in gaze of the user, and to filter the moving impairment data from at least one of the created representations of the first and at least one second iris images.

Advantageously, by causing the user to change gaze—for instance by presenting a visual pattern on a display of a smart phone in which the iris recognition system is implemented—and thereafter performing gaze-motion compensation of the captured images, a representation is created where iris features will be fixed from one representation to another in a sequence of captured images while any impairment data will move with the change in gaze.

Further advantageous is that in this aspect, it is not necessary to explicitly detect the impairment data or its specific location. Rather, by capturing a plurality of iris images where the user is caused to change gaze for each captured image, the processing unit is able to filter the moving impairment data one or more of the created representations.

In an embodiment, the filtering of the moving impairment data is attained by performing an averaging operation on the representations of the captured iris images.

In an embodiment, the filtering of the moving impairment data is attained by selecting as an iris representation a most frequently occurring iris feature pattern in the created representations.

In an embodiment, the filtering of the moving impairment data is attained by selecting as an iris representation a median iris feature pattern among feature iris patterns occurring in the representations.

In an embodiment, the filtering of the moving impairment data is attained by selecting as an iris representation a mean iris feature pattern among feature iris patterns occurring in the representations.

In an embodiment, outlier data is removed from the created representations before computing a mean iris feature pattern.

In an embodiment, any outlier data exceeding lower and upper percentiles is removed.

In an embodiment, the causing of the user to change gaze comprises subjecting the user to a visual and/or audial alert causing the user to change gaze.

In an embodiment, the causing of the user to change gaze comprises presenting a visual pattern to the user causing the user to change gaze.

In an embodiment, the causing of the user to change gaze comprises presenting a moving visual object causing the user to follow the movement with his/her eyes.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a user being located in front of a smart phone;

FIG. 2 illustrates an iris recognition system according to an embodiment;

FIG. 3 illustrates an iris of a user where interference in the form of a glint of light is present;

FIG. 4 illustrates a flowchart of a method according to an embodiment of detecting impairment data in captured iris images;

FIGS. 5a and 5b illustrate a user changing gaze between two captured iris images;

FIG. 6 illustrates the flowchart of FIG. 4 where further the effects of detected impairment data in captured iris images is mitigated according to an embodiment;

FIG. 7 illustrates an eye of a user where interference is present in the pupil;

FIG. 8 illustrates the flowchart of FIG. 4 where further the effects of detected impairment data in captured iris images is mitigated according to another embodiment;

FIGS. 9a and 9b illustrate a user changing gaze between two captured iris images;

FIG. 10 illustrates a flowchart of a method according to a further embodiment of eliminating impairment data in captured iris images;

FIG. 11 illustrates a flowchart of a method according to further embodiments of eliminating impairment data in captured iris images; and

FIGS. 12a-c illustrate visual patterns displayed to a user to cause a change in gaze according to embodiments.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

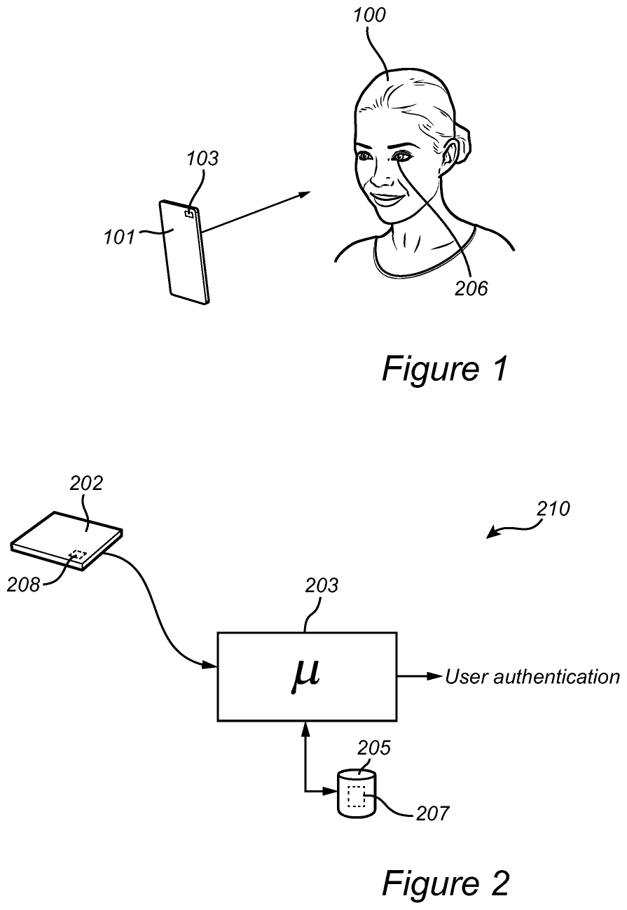

FIG. 1 illustrates a user 100 being located in front of a smart phone 101. In order to unlock the smart phone 101, a camera 103 of the smart phone 101 is used to capture one or more images of an eye 102 of the user 100.

After having captured the image(s), the user's iris is identified in the image(s) and unique features of the iris are extracted from the image and compared to features of an iris image previously captured during enrolment of the user 100. If the iris features of the currently captured image—at least to a sufficiently high degree—correspond to those of the previously enrolled image, there is a match and the user 101 is authenticated. The smart phone 101 is hence unlocked.

As previously mentioned, captured iris images may be subjected to interference or noise which is fixed with respect to a coordinate system of an image sensor of the camera 103, for instance due to image sensor imperfections, scratches or dirt on the camera lens, interfering light impinging on the user's eye, objects being present between the camera and the user, etc., which may cause impairment data to occur in a captured iris image and ultimately will result in less accurate iris feature detection. For instance, such impairment data present in a captured iris image may distort, obscure or form part of true iris features. As is understood, the impairment data being a result of the interference will also be fixed with respect to the coordinate system of the camera image sensor.

FIG. 1 illustrates the user 100 being located in front of a smart phone 101 utilizing its camera 103 to capture images of the user's eye 102. However, other situations may be envisaged, for instance a virtual reality (VR) setting where the user 100 wears e.g. a head-mounted display (HMD) being equipped with a built-in camera to capture images of the user's eyes.

Hence, any interference occurring in the path between the image sensor and the iris will lead to deterioration of biometrical performance in an iris recognition system.

Further, there may be an obstruction between a light source and the user's iris, leading to a shadow at a fixed location in an image sensor coordinate system, if the light source and the sensor have a fixed geometrical relationship to the iris throughout the sequence. Such illumination occlusion may be caused by a user's eyelashes in an HMD application.

Largely random interference will increase the false reject rate, leading to a system less convenient to the user. Largely static interference will increase the false accept rate, leading to a less secure system.

If such an iris image comprising impairment data is compared to a previously enrolled iris image, a user may be falsely rejected or erroneous authentication of a user may be performed, thus resulting in false acceptance.

As is understood, the above-discussed impairment data may also be present in an enrolled iris image. In such a scenario, authentication may be troublesome even if the currently captured iris image used for authentication is free from impairment data.

FIG. 2 shows a camera image sensor 202 being part of an iris recognition system 210 according to an embodiment implemented in e.g. the smart phone 100 of FIG. 1. The iris recognition system 210 comprises the image sensor 202 and a processing unit 203, such as one or more microprocessors, for controlling the image sensor 202 and for analysing captured images of one or both of the eyes 102 of the user 100. The iris recognition system 210 further comprises a memory 205. The iris recognition system 210 in turn, typically, forms part of the smart phone 100 as exemplified in FIG. 1. The sensor 202 and the processing unit 203 may both perform tasks of an authentication process. It may further be envisaged than in case a sensor with sufficient processing power is utilized, the sensor 202 may take over authentication tasks from the processing unit 203, and possibly even replace the processing unit 203. The sensor 202 may comprise a memory 208 for locally storing data.

The camera 103 will capture an image of the user's eye 102 resulting in a representation of the eye being created by the image sensor 202 in order to have the processing unit 203 determine whether the iris data extracted by the processing unit 203 from image sensor data corresponds to the iris of an authorised user or not by comparing the iris image to one or more authorised previously enrolled iris templates pre-stored in the memory 205.

With reference again to FIG. 2, the steps of the method performed by the iris recognition system 210 are in practice performed by the processing unit 203 embodied in the form of one or more microprocessors arranged to execute a computer program 207 downloaded to the storage medium 205 associated with the microprocessor, such as a RAM, a Flash memory or a hard disk drive. Alternatively, the computer program is included in the memory (being for instance a NOR flash) during manufacturing. The processing unit 203 is arranged to cause the iris recognition system 210 to carry out the method according to embodiments when the appropriate computer program 207 comprising computer-executable instructions is downloaded to the storage medium 205 and executed by the processing unit 203. The storage medium 205 may also be a computer program product comprising the computer program 207. Alternatively, the computer program 207 may be transferred to the storage medium 205 by means of a suitable computer program product, such as a Digital Versatile Disc (DVD) or a memory stick. As a further alternative, the computer program 207 may be downloaded to the storage medium 205 over a network. The processing unit 203 may alternatively be embodied in the form of a digital signal processor (DSP), an application specific integrated circuit (ASIC), a field-programmable gate array (FPGA), a complex programmable logic device (CPLD), etc. It should further be understood that all or some parts of the functionality provided by means of the processing unit 203 may be at least partly integrated with the fingerprint sensor 202.

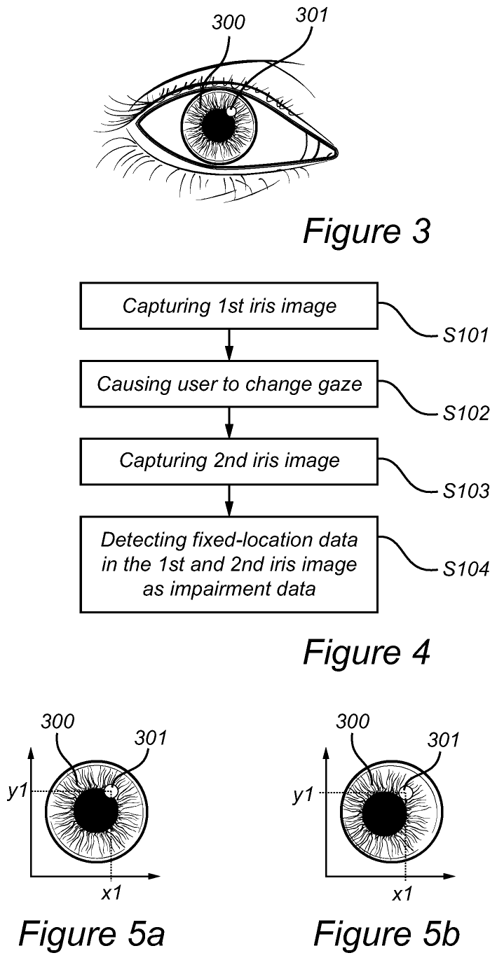

FIG. 3 illustrates an iris 300 of a user where in this example, interference 301 is present in the iris 301. As previously mentioned, this may e.g. be the result of a camera flash or ambient light impinging on the iris 300 during image capturing, dirt on the camera lens, image sensor imperfections, etc. As previously discussed, such interference 301 renders reliable iris detection more difficult since it generally obscures the iris thereby impeding iris feature detection. As is understood, the interference 301 merely serves an illustration and the interference may take on just about any form impacting iris feature detection and extraction in a captured image.

FIG. 4 illustrates a flowchart of a method according to an embodiment of detecting impairment data in captured iris images in order to eliminate, or at least mitigate, the undesired effects of interference in captured iris images resulting in impairment data occurring in the images.

Reference is further made to FIGS. 5a and 5b illustrating two slightly different captured iris images.

In a first step S101, a first iris image is captured using the camera 103 of the smart phone 101. The first iris image is illustrated in FIG. 5a where the user 100 looks more or less straight into the camera 103. As in FIG. 3, the iris 300 is subjected to interference causing impairment data 301 to be present in the iris image.

The image sensor 202 is typically arranged with coordinate system-like pixel structure where the exact location of each pixel on the images sensor 202 can be located in the coordinate system.

As is understood, from the single iris image of FIG. 5a, the processing unit 203 will typically not be able to conclude that the data 301 in the image caused by interference indeed is impairment data; the processing unit 203 may thus (incorrectly) conclude that the data 301 is a true iris feature (albeit a slightly odd-appearing feature).

Hence, in step S102, the iris recognition system 210 causes the user 100 to change gaze, for instance by providing a visual indication on a screen of the smart phone 101 which provokes the user 100 to change gaze. For instance, the user 100 is caused to turn her gaze slightly to the right, whereupon a second iris image is captured in step S103, as illustrated in FIG. 5b.

Now, as illustrated in FIGS. 5a and 5b, the impairment data 301 is present in both the first and the second iris image at a fixed coordinate x1, y1.

As a result, the processing unit 203, will advantageously in step S104 detect the data 301 present as a white dot in both images at location x1, y1 as impairment data. In other words, since the white dot 301 did not move with the change of gaze of the user 100, the white dot 301 cannot be a part of the iris 300 changing position but must be impairment data.

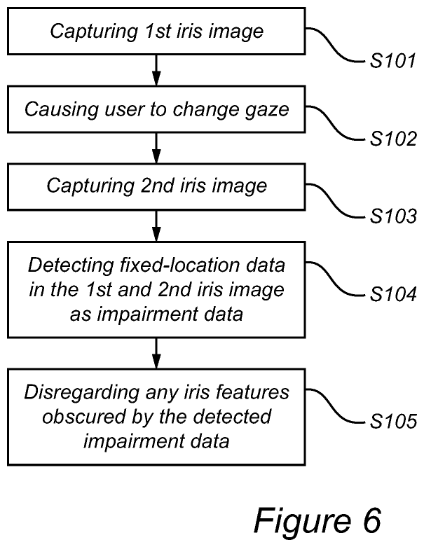

In an embodiment, with reference to the flowchart of FIG. 6 where steps S101-S104 are the steps already described with reference to FIG. 4, any iris features obscured by the impairment data 301 located at x1, y1 will in step S105 be disregarded upon performing authentication and/or enrolment of the user 100 with the iris recognition system 210.

Hence, in step S105, any detected iris features positioned at the location x1, y1 of the detected impairment data 301 will advantageously be disregarded during authentication and/or enrolment of the user 100.

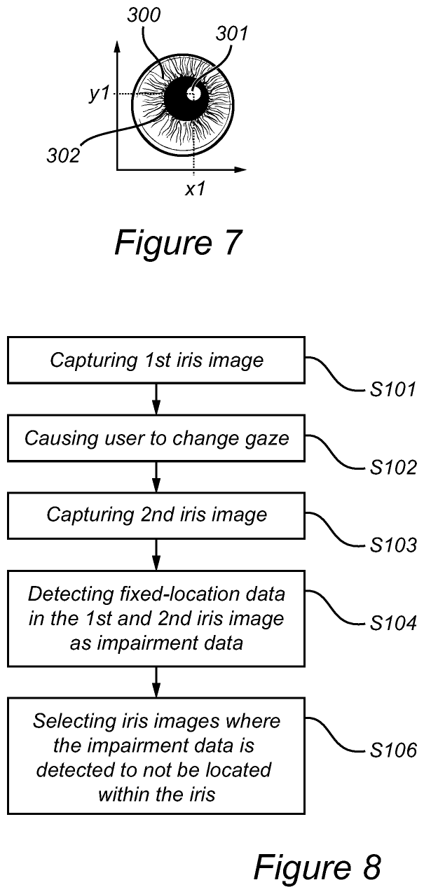

In another embodiment, with reference to an iris image illustrated in FIG. 7, if the user 100 is caused to turn her gaze slightly leftwards and upwards (in a “2 o'clock” direction), the position of the iris 300 on the image sensor 202 changes such that the impairment data 301 at location x1, y1 now is positioned within a pupil 302 of the eye.

In such a case, this particular image (but neither the iris image of FIG. 5a nor that of FIG. 5b) will be used for authentication and/or enrolment since the processing unit 203 has identified the impairment data 301 at location x1, y1 to be positioned fully within the pupil 302 and that the iris 300 likely is free from interference. Advantageously, extracted iris features can be more safely relied upon since there is no indication that the features are obscured by impairment data 301.

Similarly, a scenario where the change in gaze causes the impairment data to be fully positioned in a white of the eye (referred to as sclera) would be a suitable iris image from which iris features are extracted for the purpose of user authentication or enrolment since again, the iris would in such scenario be free from impairment data.

In an embodiment, with reference to the flowchart of FIG. 8 where steps S101-S104 are the steps already described with reference to FIG. 4, in step S106, if the processing unit 203 concludes that there are one or more captured iris images where any detected impairment data is located outside the iris of the eye, i.e. fully within the pupil or the sclera, then such iris image(s) will be used for authentication and/or enrolment, given that it is of sufficiently high quality.

Advantageously, the processing unit 203 will for authentication and/or enrolment select, in step S106, iris features in the captured iris images where the detected impairment data 301 resides at a location outside of the iris 300 of the user 100.

As is understood, this may be combined with the embodiment of disregarding any iris feature in captured images where the iris is not free from impairment data as previously discussed with reference to step S105.

In another embodiment where each spatial sample of the image sensor 202 is gaze-motion compensated (i.e. normalized) by the processing unit 203 to correspond to the same position on the iris 300 for sequentially captured iris images, the iris 300 will due to the normalization be at the same fixed position x2, y2 in the coordinate system of the image sensor 202 while the impairment data 301 will move in the coordinate system with every change in gaze of the user 100.

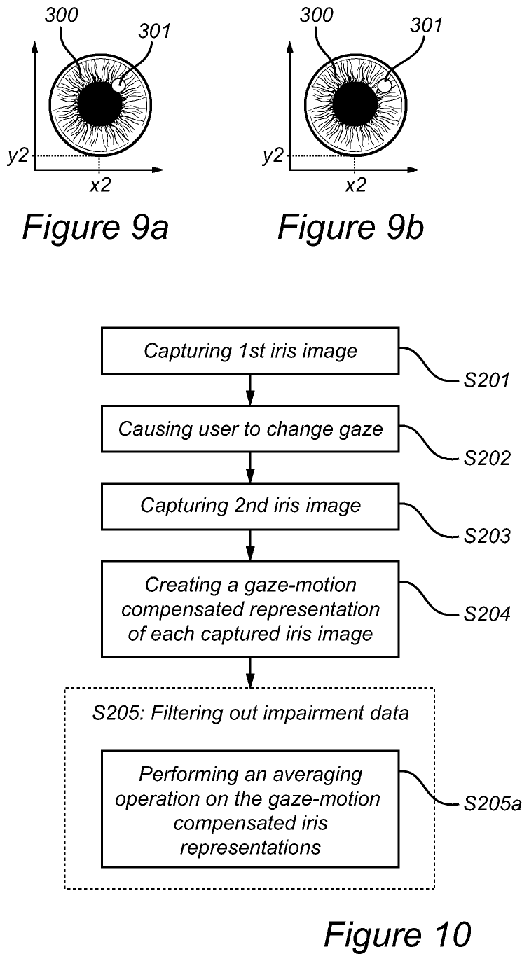

This is illustrated in FIGS. 9a and 9b along with a flowchart of FIG. 10. A first iris image is thus captured in step S201. Thereafter, the user 100 is caused to change gaze in step S202 before a second iris image is captured in step S203, where a change in gaze as previously discussed with reference to FIGS. 5a and 5b—i.e. the user 100 is caused to turn her gaze slightly to the right—in this embodiment will cause the impairment data 301 to move (corresponding to the gaze of the user 100), while the iris 300 remains in a fixed position x2, y2 since each spatial sample of the image sensor 202 is gaze-motion compensated by the processing unit 203 in step S204 to correspond to the same position on the iris 300.

Thus, the processing unit 203 creates in step S204 a representation of the first iris image and the second iris image, respectively, where each spatial sample of the image sensor 203 of the camera 103 is gaze-motion compensated to correspond to a same position on the iris 300 for the sequentially captured first second iris images, thereby causing the iris 300 to be fixed in the representations of the first and second iris images as illustrated in FIGS. 9a and 9b, while any impairment data 301 will move with the change in gaze of the user.

In this embodiment, it is not necessary to explicitly detect the impairment data 301 (or its specific location). Rather, by capturing a plurality of iris images (such as e.g. 5-10 images) where the user 100 is caused to change gaze for each captured image, the processing unit 202 is able in step S205 to filter the moving impairment data 300 from at least one of the created representations of the first and at least one second iris images (the filtered representation subsequently being used for authentication and/or enrolment of the user 100).

Determination of gaze can aid the process of filtering impairment data as it will build an expectation of apparent movement of impairments in the gaze-compensated representations.

In this particular embodiment, the filtering of the impairment data 301 is performed by subjecting the gaze-motion compensated iris representations to an averaging operation in step S205a which will cause the ever-moving impairment data to be filtered out and thus mitigated and the fixed iris features to be enhanced and thereby appear more distinct. The averaging operation may e.g. be based on computing an average using pixel intensity values of the iris representations.

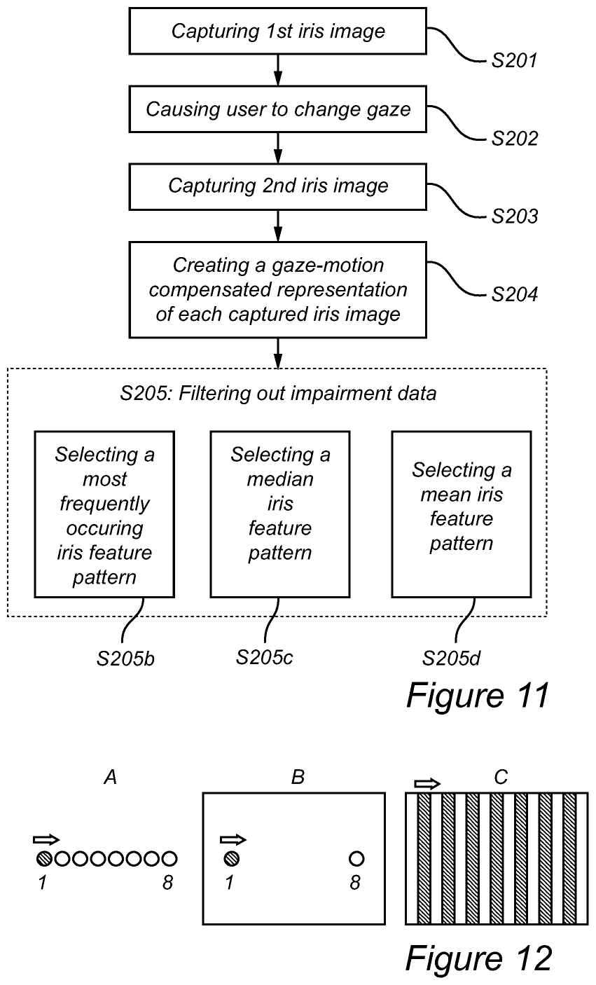

With reference to FIG. 11, in a further embodiment, rather than performing synthesis by subjecting the captured images to an averaging operation to mitigate the impact of the impairment data 301 present in the captured images, the processing unit 202 performs majority voting.

Thus, in a sequence of created gaze-motion compensated iris images—in practice typically tens of images—where the user is caused to change gaze, a most frequently occurring iris feature pattern at location x2, y2 will be selected in step S205b as an iris representation to subsequently be used for authentication and/or enrolment of the user 100, which advantageously will cause elimination, or at least mitigation, of any impairment data 301 while enhancing the iris 300.

In yet an embodiment, the processing unit 202 selects in step S205c as an iris representation a median iris feature pattern at location x2, y2 among feature iris patterns occurring in the sequence of iris representations where the user is caused to change gaze, which again advantageously will cause elimination, or at least mitigation, of any impairment data 301 while enhancing the iris 300, the rationale being that any data (e.g. impairment data) in the captured images having an appearance which deviates to a great extent from a median representation of the iris pattern is outlier data from a statistical point of view and will thus not be present in an image comprising the median iris pattern.

For the embodiment using majority voting and the embodiment using a median iris pattern, only three captured (yet disjunct) images/representations are required for impairment data elimination.

In yet a further embodiment, the processing unit 202 selects in step S205d as an iris representation a mean iris feature pattern at location x2, y2 among feature iris patterns occurring in the sequence of iris representations where the user is caused to change gaze, which again advantageously will cause elimination, or at least mitigation, of any impairment data 301 while enhancing the iris 300, the rationale being that any data (e.g. impairment data) in the captured images having an appearance which deviates to a great extent from a mean representation of the iris pattern is outlier data and will thus not be present in an image comprising the mean iris pattern.

Thus, with these three embodiments, robust statistics are used to select or form a “consensus” iris feature pattern from a population of iris feature patterns where a subset of the iris images/representations at each given location is contaminated by impairments. Further, in the case of majority voting or computation of a median and mean pattern, it is possible to eliminate the impairments while in the case of averaging the impairments have a tendency of “bleeding” into the average representation which typically only allows for mitigation of the impairments but generally not complete impairment elimination.

In practice, a user will be caused to change gaze while a plurality of images are captured having as an effect that any impairment data may more or less move from one corner of the eye to the other in the sequence of gaze-motion compensated images (even though FIGS. 9a and 9b illustrates two immediately sequential iris representation and thus only a slight movement of the impairment data 301) while the iris is fixed throughout the image sequence.

As a result, upon selecting a most frequently occurring iris pattern (S205b), a median iris pattern (S205c) or a mean iris pattern (S205d) forming the consensus iris feature representation, the impairment data will advantageously be filtered out from such a consensus iris feature pattern.

In contrast to the embodiment described with reference to FIGS. 4, 6 and 8; rather than explicitly detecting the impairment data 301 present in the captured images, the captured images are processed such that the features of the (fixed) iris 300 are enhanced while the (moving) impairment data 301 is suppressed or even eliminated by means of filtering, where the filtering is performed as described hereinabove in four exemplifying embodiments with reference to steps S205a-d, by exploiting the notion that the due to the gaze-motion compensation being performed on the captured iris images, the iris 300 will be located at the same fixed position x2, y2 in the coordinate system of the image sensor 202 throughout an iris image while the impairment data 301 will move in the coordinate system with every change in gaze of the user 100.

In a further embodiment, the mean representation of the iris pattern is computed after certain outlier data has been removed, such as any data exceeding lower and upper percentiles (e.g. below 5% and above 95% of all data). Thus, with this embodiment, the image data is advantageously “trimmed” prior to being used for creating a mean iris pattern which deviates further from any impairment data typically making the filtering more successful assuming that the outlier data cut-off has been conjured to separate the impairments from the true iris data.

As previously mentioned, image data may be represented by pixel intensity values for the majority coting or averaging operations, and the mean (and median) computations may also be based on the pixel intensity values of captured iris images, as well as derived spatial features describing the iris (e.g., spatial linear and non-linear filter responses).

As is understood, the above described embodiments have for brevity been described as utilizing only a few captured iris images to detect any interference giving rise to impairment data being present in the captured iris images. However, in practice, far more iris images may be captured where a change in gaze of the user is caused for each captured iris image, in order to detect the impairment data in, or perform averaging of, the captured images.

To cause the user 100 to change gaze, the iris recognition system 210 may in an embodiment alert the user 100 accordingly using e.g. audio or video.

FIGS. 12a-c illustrate three different approaches of visually alerting the user to change gaze and show three examples of allowing horizontal gaze diversity. The approach illustrated herein may trivially be utilized for gaze changes along other directions as well.

FIG. 12a shows a discrete implementation employing a number of illuminators that can light up in a spatially coherent sequence during image acquisition, e.g., left-to-right to stimulate gaze alteration. As is understood, in case the iris recognition system 210 is implemented in a smart phone 101, the screen of the smart phone may straightforwardly be utilized to present the 8-step pattern of FIG. 11a.

FIG. 12b shows a screen-based approach where a singular target is moved seamlessly left-to-right over time.

FIG. 12c shows a screen-based approach where a stripe pattern is translated left-to-right over time. All exemplar approaches may be preceded by instructions in the form of text, sound or video alerting the user 100 to follow the movement. Most subjects will follow the motion naturally, but an interesting aspect of the option shown in FIG. 11c is that the eye movement occurs involuntarily, provided the angular field-of-view of the presented screen is large enough by way of the so-called optokinetic nystagmus response. Furthermore, if the movement is shown for a sufficient amount of time, the eye gaze is reset by a so-called saccade and smooth pursuit eye movement is then repeated, yielding a convenient way of acquiring multiple gaze sweeps in a brief window of time.

Assisted gaze diversity—as illustrated in FIGS. 12a-c—may be employed during both enrolment and authentication. The stripe approach of FIG. 12c may be perceived as intrusive and may be most suited during enrolment, while the approach of FIGS. 12a and b is gentler on the eye of the user and thus may be used during authentication. As is understood, gaze diversity may be used during either of authentication or enrolment, or both.

The approach of FIG. 12b shares traits with the established slide-to-unlock touch screen gesture found in smart phones and tablets. A variant of this is where movement of the singular target is not occurring independently, but rather the user is asked to move the target by way of gaze in a gamification manner.

Inducing gaze diversity may thus attenuate/eliminate any interference to which an image sensor is subjected. Sources of interference include but are not limited to i) inhomogeneous pixel characteristics including offset, gain and noise, ii) inhomogeneous optical fidelity including image height-dependent aberrations and non-image forming light entering the optical system causing surface reflections, iii) environmental corneal reflections for subject-fixated acquisition systems, iv) shadows cast on iris for subject-fixated acquisition systems (such as HMDs), v) uneven illumination for subject-fixated acquisition systems and vi) objects located in the path between the camera and the eye.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of an iris recognition system of reducing impact of impairment data in captured iris images, comprising:
capturing a first image of an iris of a user;
causing the user to change gaze;
capturing at least a second image of the iris of the user; and
detecting data in the first and the second iris image as impairment data if a location of said data is fixed in the first and the second iris image.

2. The method of claim 1, further comprising:
disregarding any iris features positioned at the location of the detected impairment data in the captured iris images during authentication and/or enrolment of the user.

3. The method of claim 1, further comprising:
selecting, for authentication and/or enrolment of the user, iris features in the captured iris images where the detected impairment data resides at a location outside of the iris of the user.

4. A method of an iris recognition system of reducing impact of impairment data in captured iris images, comprising:
capturing a first image of an iris of a user;
causing the user to change gaze;
capturing at least a second image of the iris of the user;
creating a representation of the first iris image and a representation of the at least one second iris image where each spatial sample of an image sensor of a camera capturing the iris images is gaze-motion compensated to correspond to a same position on the iris for the sequentially captured first and at least one second iris images, thereby causing the iris to be fixed in the representations of the first and at least one second iris images while any impairment data will move with the change in gaze of the user; and
filtering the moving impairment data from at least one of the created representations of the first and at least one second iris images.

5. The method of claim 4, the filtering of the moving impairment data from at least one of the created representations of the first and at least one second iris images comprising:
performing an averaging operation on the representations of the captured iris images.

6. The method of claim 4, the filtering of the moving impairment data from at least one of the created representations of the first and at least one second iris images comprising:
selecting as an iris representation a most frequently occurring iris feature pattern in the created representations.

7. The method of claim 4, the filtering of the moving impairment data from at least one of the created representations of the first and at least one second iris images comprising:
selecting as an iris representation a median iris feature pattern among feature iris patterns occurring in the representations.

8. The method of claim 4, the filtering of the moving impairment data from at least one of the created representations of the first and at least one second iris images comprising:
selecting as an iris representation a mean iris feature pattern among feature iris patterns occurring in the representations.

9. The method of claim 8, further comprising:
removing outlier data from the created representations before computing a mean iris feature pattern.

10. The method of claim 9, wherein any outlier data exceeding lower and upper percentiles is removed.

11. The method of claim 1, the causing of the user to change gaze comprising:
subjecting the user to a visual and/or audial alert causing the user to change gaze.

12. The method of claim 11, the causing of the user to change gaze comprising:
presenting a visual pattern to the user causing the user to change gaze.

13. The method of claim 12, the causing of the user to change gaze comprising:
presenting a moving visual object causing the user to follow the movement with his/her eyes.

14. The method of claim 13, the moving visual object being arranged such that an optokinetic nystagmus response of the user is exploited.

15. (canceled)

16. A computer program product comprising a non-transitory computer readable medium, the computer readable medium having the computer program embodied thereon, the computer program comprising computer-extendable instructions for causing an iris recognition system to perform the method of claim 1 when the computer-executable instructions are executed on a processing unit included in the iris recognition system.

17.-19. (canceled)

20. An iris recognition system configured to reduce impact of impairment data in captured iris images, comprising a camera configured to:
capture a first image of an iris of a user;
capture at least a second image of the iris of the user; and
comprising a processing unit being configured to:
cause the user to change gaze between the capturing of the first image and the at least one second image;
create a representation of the first iris image and a representation of the at least one second iris image where each spatial sample of an image sensor of the camera capturing the iris images is gaze-motion compensated to correspond to a same position on the iris for the sequentially captured first and at least one second iris images, thereby causing the iris to be fixed in the representations of the first and at least one second iris images while any impairment data will move with the change in gaze of the user; and to
filter the moving impairment data from at least one of the created representations of the first and at least one second iris images.

21. The iris recognition system of claim 20, the processing unit being configured to, when filtering the moving impairment data from at least one of the created representations of the first and at least one second iris images:
perform an averaging operation on the representations of the captured iris images.

22. The iris recognition system of claim 20, the processing unit being configured to, when filtering the moving impairment data from at least one of the created representations of the first and at least one second iris images:
select as an iris representation a most frequently occurring iris feature pattern in the created representations.

23. The iris recognition system of claim 20, the processing unit being configured to, when filtering the moving impairment data from at least one of the created representations of the first and at least one second iris images:
select as an iris representation a median iris feature pattern among feature iris patterns occurring in the representations.

24. The iris recognition system of claim 20, the processing unit being configured to, when filtering the moving impairment data from at least one of the created representations of the first and at least one second iris images:
select as an iris representation a mean iris feature pattern among feature iris patterns occurring in the representations.

25.-30. (canceled)
